(19) United States
(12) Patent Application Publication
(10) Pub. No.: US 2021/0273790 A1
(43) Pub. Date: Sep. 2, 2021

(54) CLIENT DEVICE

(71) Applicant: Mitsubishi Electric Corporation, Tokyo (JP)

(72) Inventor: Daisuke SUZUKI, Tokyo (JP)

(73) Assignee: Mitsubishi Electric Corporation, Tokyo (JP)

(21) Appl. No.: 17/318,820

(22) Filed: May 12, 2021

Related U.S. Application Data
(63) Continuation of application No. PCT/JP2019/000294, filed on Jan. 9, 2019.

(51) Int. Cl. H04L 9/08; H04L 9/14

(52) U.S. Cl. CPC H04L 9/0825; H04L 9/0822; H04L 2209/125; H04L 9/14; H04L 9/0894

(57) ABSTRACT

A secure computation device (1) includes a host computation unit (10) and an FPGA (405). The host computation unit (10) forms a logic circuit in the FPGA (405). The FPGA (405) includes a key computation circuit (222) to generate a public key Kp and a secret key (Ks) from an initial value (IV), acquire a secret key (Cmk) encrypted with the public key (Ks), and decrypt the secret key (Cmk) with the secret key Ks; a decryption operation circuit (224) to acquire encrypted data (Ca) resulting from encrypting content (Q) with a secret key (mk), and decrypt the encrypted data (Ca) with the decrypted secret key mk; a high-speed operation circuit (225) to perform processing (Func) on the content (Q) to generate processed content Q; an encryption circuit (226) to encrypt the processed content (Q) with the secret key (mk); and an output circuit (227) to output encrypted data of the processed content Q.

### CROSS REFERENCE TO RELATED APPLICATION

This application is a Continuation of PCT International Application No. PCT/JP2019/000294, filed on Jan. 9, 2019, which is hereby expressly incorporated by reference into the present application.

### TECHNICAL FIELD

The present invention relates to a secure computation device that performs secure computation and a client device that requests secure computation.

### BACKGROUND ART

<Secure Computation>

Secure computation is a technique to perform operations by a specified function while maintaining the privacy of data. For example, Patent Literature 1 discloses a secure computation control device using homomorphic encryption, which is not limited to particular operations.

<Cloud FPGA>

The provision of a computing instance equipped with a field programmable gate array (FPGA) has become popular as a cloud service. For example, Amazon EC2 F1 may be pointed out. In this cloud service, an FPGA is dynamically reconfigured from an application, and an operation that becomes a bottleneck in the application is offloaded to the FPGA, so that processing can be accelerated.

<PUF>

A physical unclonable function (PUF) is a technique to generate an ID that is unique to a device utilizing variations in manufacturing of large scale integration (LSI). For example, Patent Literature 2 discloses an ID generation technique utilizing the fact that transient transitions of outputs vary depending on manufacturing variations even for the same logic circuit. Generally, such IDs utilizing manufacturing variations include errors each time an ID is generated. As a technique for correcting and making adjustments for these errors so as to generate the same ID each time, there is a fuzzy extractor of Non-Patent Literature 1.

### CITATION LIST

### Patent Literature

Patent Literature 1: JP 2016-136190 A

Patent Literature 2: WO 2011/086688 A1

### Non-Patent Literature

Non-Patent Literature 1: Fuzzy Extractors: How to Generate Strong Keys from Biometrics and Other Noisy Data, Eurocrypt 2004 pp. 523-540

### SUMMARY OF INVENTION

### Technical Problem

Existing secure computation involves operations with high computational costs such as homomorphic encryption. Therefore, a case in which secure computation is applied to light processing such as addition, subtraction, and comparison has feasibility. However, existing techniques are not suitable for secure computation for processing with high computational costs such as recognition processing on images, flexible database searching, or compression.

It is an object of the present invention to provide a device that accelerates processing with high computational costs by hardware processing and also realizes secure computation.

### Solution to Problem

A secure computation device according to the present invention includes

a host computation unit; and a logic circuit device in which a circuit configuration of a logic circuit can be changed by circuit information,

wherein the host computation unit forms a plurality of logic circuits in the logic circuit device, using the circuit information associated with an application, and

wherein the logic circuit device in which the plurality of logic circuits are formed includes

a key computation circuit to generate a pair of a public key and a secret key using an initial value, acquire a user secret key encrypted with the public key, and decrypt the encrypted user secret key with the secret key;

a decryption operation circuit to acquire content encrypted with the user secret key, and decrypt the encrypted content with the decrypted user secret key;

a content operation circuit to perform processing associated with the application on the decrypted content so as to generate processed content, which is a processing result of the content;

an encryption operation circuit to encrypt the processed content with the user secret key; and

an output circuit to output the encrypted processed content.

### Advantageous Effects of Invention

A secure computation device of the present invention includes a host computation unit and a logic circuit device, so that it is possible to provide a device that accelerates processing with high computational costs by hardware processing and also realizes secure computation.

### BRIEF DESCRIPTION OF DRAWINGS

FIG. 1 is a diagram of a first embodiment and illustrates an overall configuration of a secure computation device 1;

FIG. 2 is a diagram of the first embodiment and illustrates a hardware configuration of the secure computation device 1;

FIG. 3 is a diagram of the first embodiment and illustrates a specific hardware configuration of a host computer 401;

FIG. 4 is a diagram of the first embodiment and illustrates a hardware configuration of a client device 406;

FIG. 5 is a diagram of the first embodiment and illustrates an overall processing flow of secure computation in a client-server model;

FIG. 6 is a diagram of the first embodiment and illustrates a circuit configuration of a high-speed computation circuit 20 formed in an FPGA 405;

FIG. 7 is a diagram of the first embodiment and illustrates a circuit configuration of a key computation circuit 222;

FIG. 8 is a diagram of the first embodiment and illustrates a key storage circuit 223 when an application manages a plurality of secret keys mk;

FIG. 9 is a diagram of the first embodiment and illustrates the high-speed computation circuit 20 of a first variation;

FIG. 10 is a diagram of the first embodiment and illustrates host computers 401a and 401b of the first variation;

FIG. 11 is a diagram of the first embodiment and illustrates a hardware configuration of the host computer 401a of the first variation;

FIG. 12 is a diagram of the first embodiment and illustrates a hardware configuration of a VM management device 700 of the first variation;

FIG. 13 is a diagram of the first embodiment and illustrates a processing flow of a second variation; and

FIG. 14 is a diagram of the first embodiment and illustrates a processing flow of a third variation.

### DESCRIPTION OF EMBODIMENTS

<Notations>

Notations to be used in a first embodiment hereinafter will be described.

PUF_KeyGen(IV)→(HD, Kp, Ks) (Formula 101)

Formula 101 is processing using the PUF, fuzzy extractors, and a key algorithm of public key cryptography. Formula 101 indicates processing to generate auxiliary data HD, a public key Kp, and a secret key Ks, using an initial value IV.

PRF: Denotes a pseudorandom function, for example, SHA-256.

Zn: Residue class group

×: Elliptic scalar multiplication

+: Point addition on an elliptic curve

Enc(Kp, mk) (Formula 102)

Formula 102 indicates encryption of a secret key mk with the public key Kp.

PUF_KeyRep (IV, HD)→Ks (Formula 103)

Formula 103 indicates processing to generate a secret key Ks, using the PUF, fuzzy extractors, and the key algorithm of public key cryptography. Formula 103 signifies performing regeneration processing by the PUF and fuzzy extractors, using an initial value IV and auxiliary data HD, so as to generate Ks.

Dec(Ks, Cmk) (Formula 104)

Formula 104 indicates processing to decrypt Cmk with the secret key Ks.

E(mk, P) (Formula 105)

Formula 105 indicates processing to encrypt P with the secret key mk in common key cryptography.

D(mk, Ca) (Formula 106)

Formula 106 indicates processing to decrypt Ca with the secret key mk in common key cryptography.

### First Embodiment

Description of Configuration

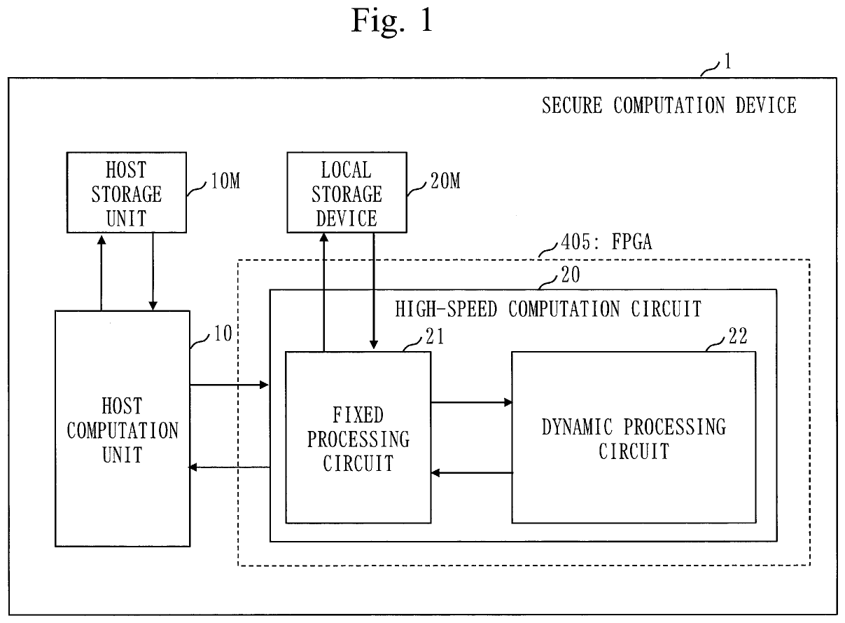

Referring to FIGS. 1 to 12, a secure computation device 1 will be described.

FIG. 1 is a diagram illustrating an overall configuration of the secure computation device 1. The secure computation device 1 includes a host computation unit 10, a host storage unit 10M, a high-speed computation circuit 20, and a local storage device 20M. The high-speed computation circuit 20 includes a fixed processing circuit 21 and a dynamic processing circuit 22. The local storage device 20M is accessed by the fixed processing circuit 21.

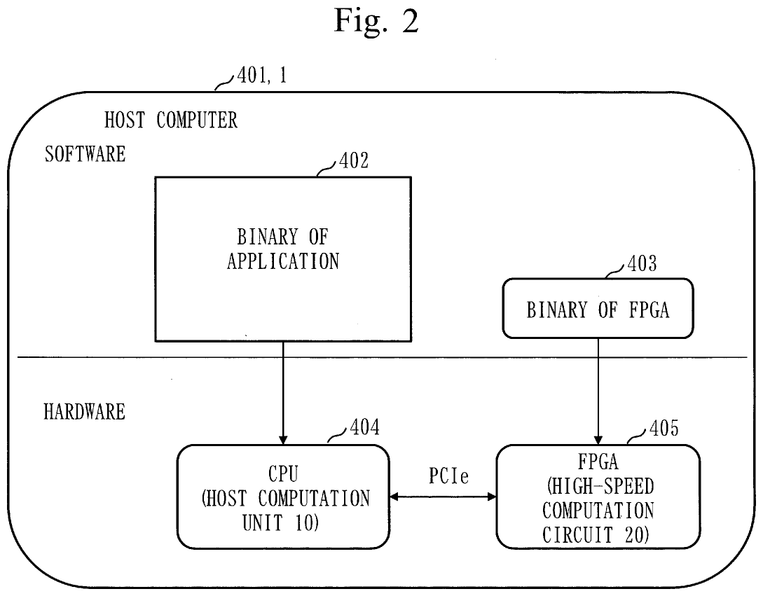

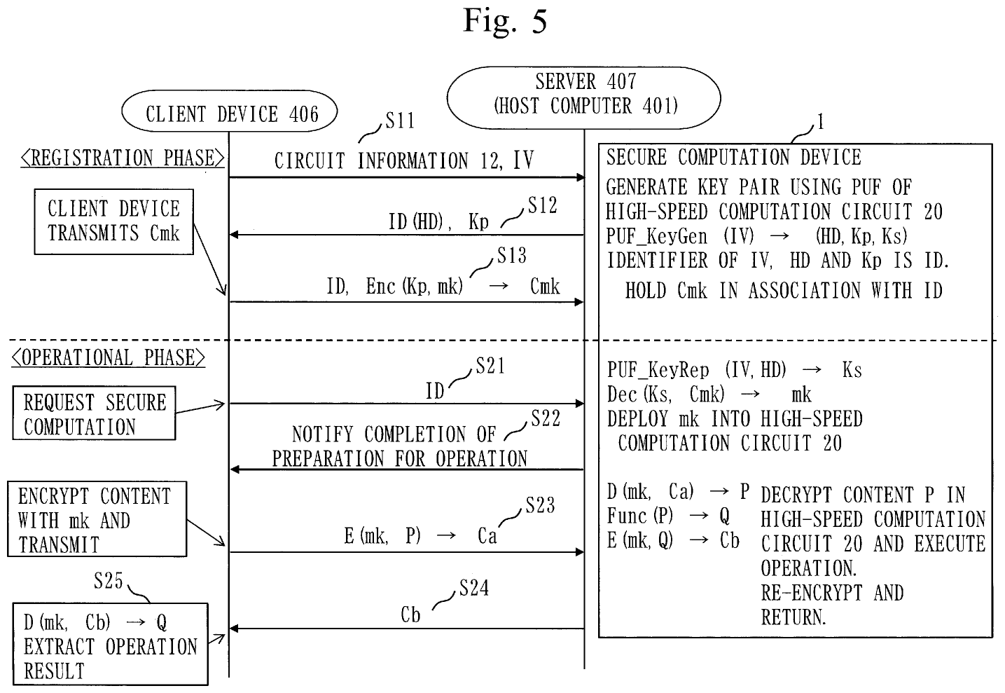

FIG. 2 illustrates a hardware configuration of the secure computation device 1 of FIG. 1. The host computation unit 10 and a logic circuit device in which the circuit configuration of a logic circuit can be changed by circuit information 12 are included. An FPGA 405 is the logic circuit device. The host computation unit 10 is realized by execution of a binary 402 of an application by a CPU 404. The host computation unit 10 forms a plurality of logic circuits in the FPGA 405, which is the logic circuit device, using the circuit information 12 associated with the application. The circuit information 12 is transmitted from a client device 406 in step S11 of FIG. 5 to be described later. The binary 402 of the application is processed in the central processing unit (CPU) 404 of a host computer 401. The binary 402 of the application is processed by the host computation unit 10 in FIG. 1.

The high-speed computation circuit 20 is realized by the FPGA 405 of the host computer 401. The CPU 404 that processes the binary 402 of the application loads a binary 403, which is different for each application, of the FPGA 405 into the FPGA 405 to change circuits that are configured in the FPGA. Operations are accelerated on a per application basis by the circuits that are configured in the FPGA 405.

The fixed processing circuit 21 and the dynamic processing circuit 22 that are included in the high-speed computation circuit 20 of FIG. 1 will be described. The fixed processing circuit 21 processes functions, such as memory accesses, that are not dependent on operations for which processing is to be accelerated. The high-speed computation circuit 20 is realized by the FPGA 405. However, the fixed processing circuit 21 in the high-speed computation circuit 20 is not dynamically reconfigured and configured with a fixed circuit.

The dynamic processing circuit 22 is a circuit for operations to be accelerated and the circuit configuration changes for each application. That is, in the dynamic processing circuit 22, the operations to be accelerated vary with the application to be executed by the host computation unit 10. As processing, compression processing, search query processing, and recognition processing in a neural network may be pointed out.

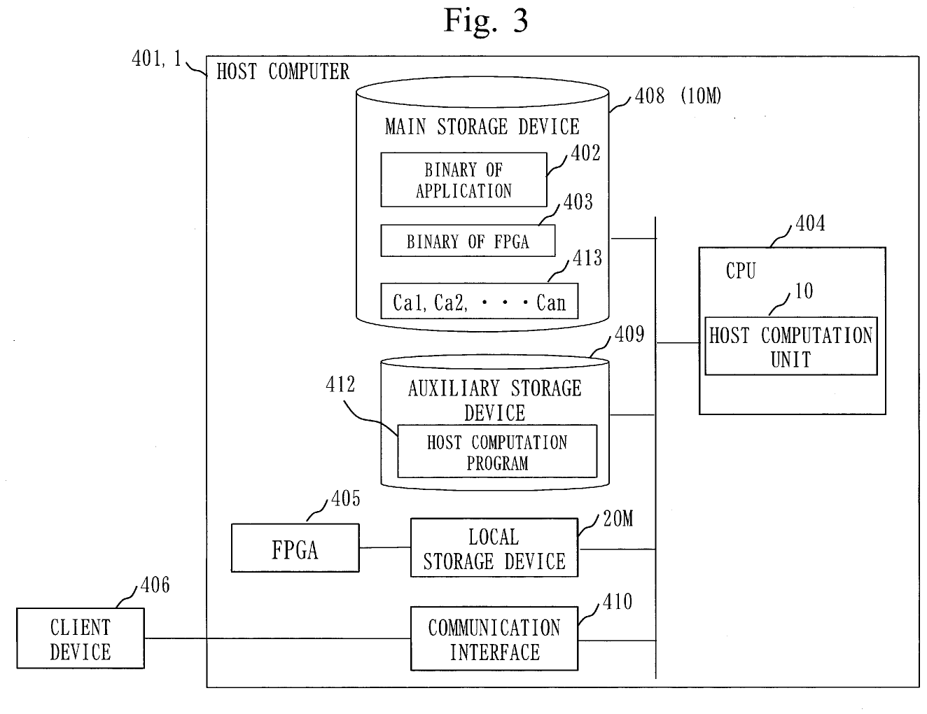

FIG. 3 illustrates a specific hardware configuration of the host computer 401. In FIG. 5 to be described later, a client-server model will be described. The secure computation device 1 is the host computer 401 and also a server 407. The host computer 401 includes, as hardware, the CPU 404, a main storage device 408, an auxiliary storage device 409, the local storage device 20M, a communication interface 410, and the FPGA 405. The CPU 404 is circuitry. The FPGA 405 is connected with the local storage device 20M. The main storage device 408 is the host storage unit 10M. Alternatively, the auxiliary storage device 409 is the host storage unit 10M. In the following description, the main storage device 408 is the host storage unit 10M. The host computer 401 has the host computation unit 10 as a functional element. The host computation unit 10 is realized by execution of a host computation program 412 by the CPU 404. The host computation program 412 is stored in the auxiliary storage device 409. The host computation unit 10 communicates with the client device 406 via the communication interface 410.

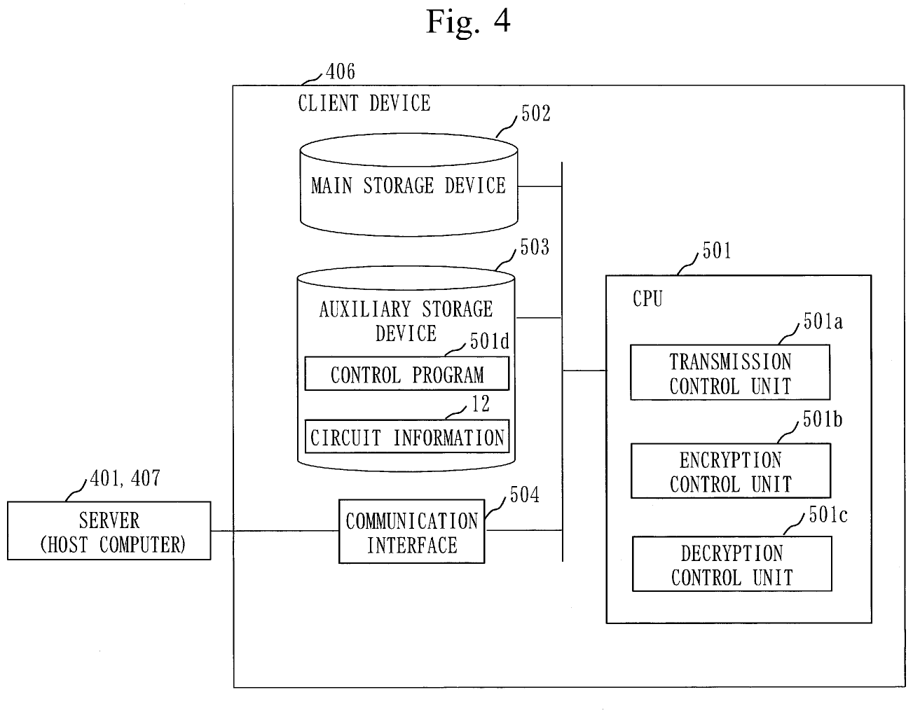

FIG. 4 illustrates a hardware configuration of the client device 406 that appears in the description of FIG. 5. The client device 406 includes, as hardware, a CPU 501, a main storage device 502, an auxiliary storage device 503, and a communication interface 504. The client device 406 has, as functional elements, a transmission control unit 501a, an encryption control unit 501b, and a decryption control unit 501c. The functions of the transmission control unit 501a, the encryption control unit 501b, and the decryption control unit 501c are realized by execution of a control program 501d by the CPU 501. The control program 501d and the circuit information 12 are stored in the auxiliary storage device 503. The CPU 501 communicates with the server 407 via the communication interface 504.

Description of Operation

Operation of the secure computation device 1 of FIG. 1 will be described. The host computation unit 10 performs processing involving read and write accesses to the host storage unit 10M. In the following, read and write accesses will be denoted as R/W. Processing with a high processing load is processed by the high-speed computation circuit 20 instead of the host computation unit 10. This processing is processing Func indicated in Formula 9 to be described later. In the following, this will be referred to as acceleration. Detailed operation of acceleration is as described below. The host computation unit 10 transfers data to be processed by the high-speed computation circuit 20 to the local storage device 20M via the fixed processing circuit 21.

Generally, this transfer is performed using direct memory access (DMA). The data transferred to the local storage device 20M is transferred in designated units to the dynamic processing circuit 22 via the fixed processing circuit 21. The dynamic processing circuit 22 executes specified processing Func at high speed, and transfers a processing result to the local storage device 20M via the fixed processing circuit 21. Finally, an operation result is transferred from the local storage device 20M to the host storage unit 10M using DMA.

The first embodiment provides means for realizing secure computation in acceleration.

FIG. 5 illustrates an overall processing flow of secure computation in the client-server model. The overall secure computation is assumed to be processing using the client-server model. In the overall secure computation, it is assumed that the server 407 responds to an operation request from the client device 406, executes designated processing, and returns a processing result to the client device 406. The first embodiment aims to prevent input data, output data, and their intermediate values of an operation to which secure computation is to be applied from being revealed in plaintext in a non-secure area on the server side in the client-server model. In FIG. 1, the non-secure area is the host computation unit 10, the host storage unit 10M, the local storage device 20M, and an area in the high-speed computation circuit 20 to and from which R/W can be performed from the host computation unit 10. A secure area is an area in the high-speed computation circuit 20 that cannot be directly accessed from the host computation unit 10. In the hardware configuration of FIG. 2, the secure area is the high-speed computation circuit 20 of the FPGA 405 to and from which R/W cannot be performed directly from the CPU 404.

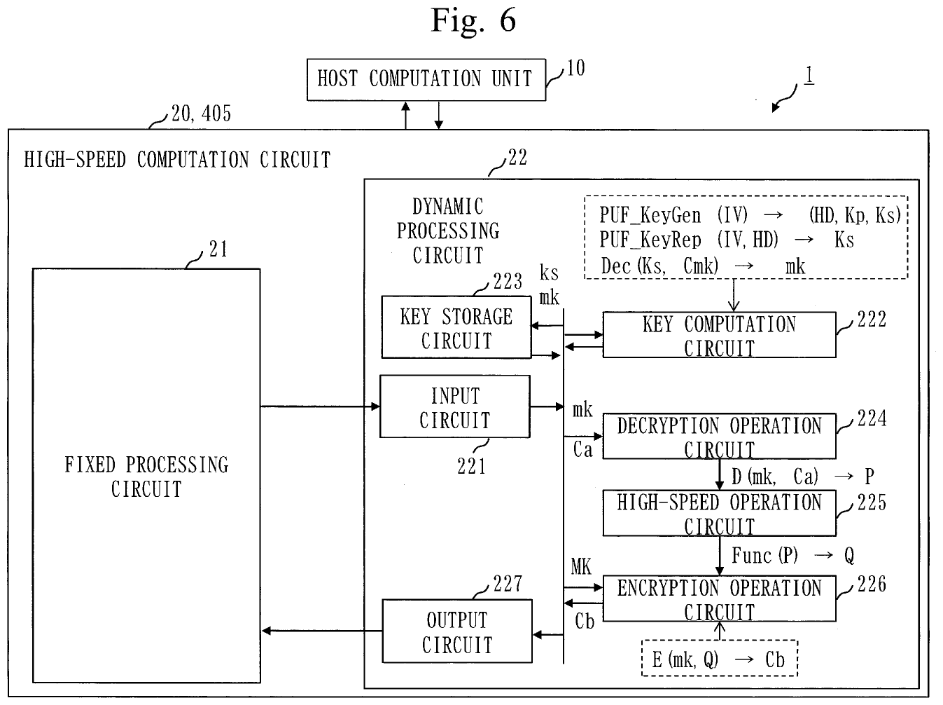

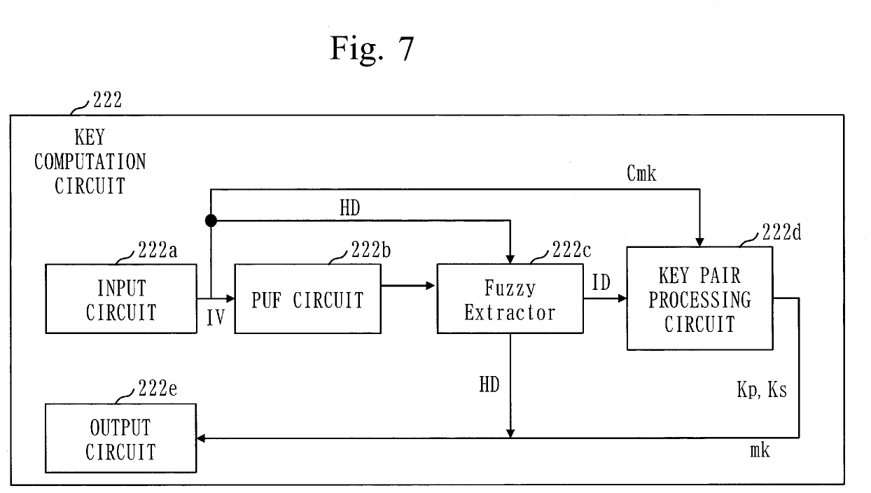

The processing flow of FIG. 5 will be described. However, before describing FIG. 5, a circuit configuration of the high-speed computation circuit 20 illustrated in FIG. 6 and a key computation circuit 222 illustrated in FIG. 7 will be briefly described. FIGS. 6 and 7 will be described in detail later.

FIG. 6 illustrates the circuit configuration of the high-speed computation circuit 20 formed in the FPGA 405. The high-speed computation circuit 20 includes the fixed processing circuit 21 and the dynamic processing circuit 22. The dynamic processing circuit 22 includes an input circuit 221, the key computation circuit 222, a key storage circuit 223, a decryption operation circuit 224, a high-speed operation circuit 225, an encryption operation circuit 226, and an output circuit 227. The high-speed operation circuit 225 is a content operation circuit.

FIG. 7 illustrates a circuit configuration of the key computation circuit 222 in FIG. 6. The key computation circuit 222 generates a pair of a public key Kp and a secret key Ks using an initial value IV. The key computation circuit 222 acquires a user secret key encrypted with the public key Kp, and decrypts the encrypted user secret key with the secret key Ks.

Specifically, this is as follows: the key computation circuit 222 includes an input circuit 222a, a PUF circuit 222b, a fuzzy extractor 222c, a key pair processing circuit 222d, and an output circuit 222e. Note that PUF is a function generally called a physical unclonable function. FIG. 5 will be described below.

In FIG. 5, the section above the dashed line indicates a registration phase, and the section below the dashed line indicates an operational phase. The processing flow is composed of two phases, the registration phase and the operational phase. In the registration phase, the dynamic processing circuit 22 registers encrypted data Cmk resulting from encrypting a secret key mk of the client device 406 in the secure computation device 1. The secret key mk is a user secret key. The secret key Ks is a first secret key and the secret key mk is a second secret key. In the operational phase, the dynamic processing circuit 22 performs secure computation including acceleration, using the secret key mk.

<Step S11>

The registration phase will be described. The transmission control unit 501a of the client device 406 transmits circuit information 12 and an initial value IV to the server 407, which is the secure computation device 1.

(1) The circuit information 12 is information used for generating the binary 403 of the FPGA 405. The circuit information 12 is design information before placement and wiring. As mentioned in the description of FIG. 2, the circuit of the FPGA 405 is dynamically configured by the binary 403 of the FPGA 405.

(2) The initial value IV is a value used for generating a key pair of public key cryptography.

A server application configures the circuits of the dynamic processing circuit 22 in the FPGA 405, as illustrated in FIG. 6, based on the circuit information 12. The dynamic processing circuit 22 configured by the server application has the key computation circuit 222 illustrated in FIG. 7. By configuring the key computation circuit 222 in the FPGA 405, the client device 406 securely stores the secret key mk in the server 407 by acquiring the public key Kp from the server 407, as described below.

A key pair of public key cryptography is generated as described below. The transmission control unit 501a of the client device 406 transmits the initial value IV together with the circuit information 12 to the server 407. The key computation circuit 222 of the dynamic processing circuit 22 receives the initial value IV via the host computation unit 10, and generates a key pair of public key cryptography using the initial value IV.

That is, the key computation circuit 222 computes Formula 1.

PUF_KeyGen (IV)→(HD, Kp, Ks) (Formula 1)

In Formula 1, HD denotes auxiliary data necessary for regenerating an identifier ID using the PUF function such as a fuzzy extractor, and Kp and Ks denote a public key and a secret key in public key cryptography, respectively.

The generation of a secret key Ks and a public key Kp in elliptic ElGamal encryption will be described as an example below.

The PUF circuit 222b and the fuzzy extractor 222c of the key computation circuit 222 take as input an initial value IV, and output an identifier ID and auxiliary data HD necessary for regeneration.

Then, the key pair processing circuit 222d compresses the identifier ID by a pseudorandom function PRF to generate a secret key Ks.

That is, the key pair processing circuit 222d computes Formula 2.

PRF(ID)→Ks(Ks ∈ Zn) (Formula 2)

Note that E(K) denotes an elliptic curve on a field K, G ∈ E(K) denotes a base point, and n denotes order of G. The key pair processing circuit 222d generates a public key Kp based on the following Formula 3.

Ks×G→Kp (Formula 3)

The key generation method is not limited to the above method. Any method that uniquely generates Kp and Ks using the identifier ID may be used.

<Step S12>

The host computation unit 10 of the server 407 transmits the public key Kp and one of the auxiliary data HD and the identifier ID to the client device 406 via the communication interface 410. In FIG. 5, the server 407 transmits the identifier ID. The auxiliary data HD and the identifier ID are associated with each other. The FPGA 405 can identify the identifier ID from the auxiliary data HD and can identify the auxiliary data HD from the identifier ID. Therefore, the server 407 may transmit either one of the auxiliary data HD and the identifier ID. In step S13 to be described later, the client device 406 transmits the identifier ID to the server 407. When the identifier ID is received from the client device 406, the server 407 can regenerate the secret key Ks, as indicated in Formula 5 to be described later, using the auxiliary data HD associated with the identifier ID.

<Step S13>

The encryption control unit 501b acquires the public key Kp from the secure computation device 1 (step S12), encrypts a secret key mk with the public key Kp, and transmits encrypted data Cmk representing the encrypted secret key mk to the secure computation device 1. That is, the encryption control unit 501b of the client device 406 transmits to the server 407 the encrypted data Cmk resulting from encrypting the secret key mk, which is used for secure computation, with the public key Kp.

This is expressed as Cmk=Enc(Kp, mk).

The encrypted data Cmk in the example of elliptic ElGamal encryption is as described below.

Let the secret key mk be an x coordinate, and MK be a message resulting from obtaining a corresponding y coordinate and converting the coordinates into a point on an elliptic curve.

Enc(Kp, mk)=(rG, r×Kp+MK)→(C1, C2)=Cmk (Formula 4)

Note that r ∈ Zn is a random number. The transmission control unit 501a of the client device 406 transmits the auxiliary data HD (or the identifier ID) and Cmk to the server 407. The processing up to here is the registration phase.

The operational phase will now be described.

<Step S21>

The client device 406 makes a request for a secure operation to the server 407. As the request for a secure operation, the transmission control unit 501a of the client device 406 transmits the identifier ID received in step S12 to the server 407. As the request for a secure operation, the client device 406 requests the server 407 that the encrypted data Cmk transmitted in step S13 in the registration phase be deployed by the high-speed computation circuit 20.

<Step S22>

The host computation unit 10 of the server 407 loads the initial value IV and the auxiliary data HD that are associated with the identifier ID into the key computation circuit 222 of the high-speed computation circuit 20. The key computation circuit 222 regenerates the identifier ID. The secret key Ks is regenerated from the generated identifier ID. That is, the key computation circuit 222 computes Formula 5.

PUF_KeyRep(IV, HD)→Ks (Formula 5)

The key computation circuit 222 decrypts Cmk using the secret key Ks to acquire the secret key mk, and deploys the secret key mk into a storage area of the decryption operation circuit 224. That is, the key computation circuit 222 computes Formula 6 to deploy the secret key mk into the storage area of the decryption operation circuit 224.

Dec(Ks, Cmk)=C2−Ks×C1→mk (Formula 6)

Note that the area in the decryption operation circuit 224 in which the secret key mk is stored is designed to be configured such that the area cannot be directly accessed from the host computation unit 10. For example, it is stored in a register in the FPGA 405 from which a read cannot be performed.

The host computation unit 10 of the server 407 notifies the client device 406 of completion of the deployment of the secret key mk. That is, the server 407 notifies the client device 406 of completion of the preparation for the operation.

<Step S23>

The encryption control unit 501b encrypts content P with the secret key mk, and transmits encrypted data Ca representing the encrypted content P to the secure computation device 1. That is, the encryption control unit 501b transmits to the server 407 the encrypted data Ca resulting from encrypting the content P to be operated on with the secret key mk. The encryption control unit 501b of the client device 406 computes Formula 7.

E(mk, P)→Ca (Formula 7)

The key computation circuit 222 acquires the content encrypted with the secret key mk, and decrypts the encrypted content with the decrypted secret key mk. Specifically, this is as follows: the decryption operation circuit 224 decrypts Ca with the secret key mk to acquire the content P.

That is, the decryption operation circuit 224 computes Formula 8.

D(mk, Ca)→P (Formula 8)

Then, the high-speed operation circuit 225, which is the content operation circuit, performs the processing Func associated with the application on the decrypted content, so as to generate processed content, which is a processing result of the content P. Specifically, this is as described below.

In the following, a processing result Q is the processed content. The high-speed operation circuit 225 performs the processing Func, to which acceleration and secure computation are to be applied, on the content P to obtain the processing result Q. That is, the high-speed operation circuit 225 computes Formula 9.

Func(P)→Q (Formula 9)

The encryption operation circuit 226 encrypts the processing result Q with the secret key mk to obtain encrypted data Cb. That is, the encryption operation circuit 226 computes Formula 10.

E(mk, Q)→Cb (Formula 10)

<Step S24>

The encryption operation circuit 226 transmits the encrypted data Cb to the client device 406 via the host computation unit 10.

<Step S25>

The decryption control unit 501c acquires the encrypted processed content from the secure computation device, and decrypts the encrypted processed content with the user secret key. Specifically, the decryption control unit 501c of the client device 406 decrypts the encrypted data Cb using the secret key mk so as to obtain the processing result Q. That is, the decryption control unit 501c computes Formula 11.

D(mk, Cb)→Q (Formula 11)

In this operational phase, the content P is treated as information transmitted from the client device 406. However, it may be configured such that information resulting from encrypting part of the content P with the secret key mk is loaded from the host storage unit 10M into the decryption operation circuit 224.

For example, searching in a database is assumed. It is assumed that there are a plurality of pieces of information encrypted with the secret key mk in the host storage unit 10M. It may be configured such that the server 407 receives a query encrypted with the secret key mk from the client device 406, and processing is triggered by the query. This query corresponds to the encrypted data Ca of step S23. The key computation circuit 222 acquires content encrypted with the secret key mk from an encrypted content storage device to store content encrypted with the secret key mk.

Specifically, this is as described below.

Referring to FIG. 3, description will be provided. The main storage device 408 of FIG. 3 stores database information 413. The main storage device 408 is the encrypted content storage device.

The main storage device 408 corresponds to the host storage unit 10M. It is assumed that the content P can be divided into a plurality of subcontent P1 to subcontent Pn. P1 to Pn are encrypted to Ca1 to Can by the above Formula 7.

E(mk, P1)→Ca1,

E(mk, P2)→Ca2,

E(mk, Pn)→Can,

where Ca1 to Can are stored in the main storage device 408 as the database information 413. Ca1 to Can are encrypted content.

The key computation circuit 222 of the server 407 can decrypt Ca1 to Can with the secret key mk obtained by the above Formula 6.

<Specific Example of the Operational Phase>

As a more specific example, the operational phase will be described using an example in which acceleration is applied to the Smith-Waterman algorithm that calculates scores for two character strings to compute local alignments. The local alignments of base sequences TGTTACGG and GGTTGACTA are GTT-AC and GTTGAC, respectively. In the operational phase described with reference to FIG. 5, this processing is performed as described below.

The client device 406 encrypts TGTTACGG and GGTTGACTA with the secret key mk, and transmits them as encrypted data Ca to the server 407. This corresponds to step S23. The high-speed operation circuit 225 to execute the processing Func executes the Smith-Waterman algorithm as the processing Func. This is processed as described below. The following processing corresponds to processing by the decryption operation circuit 224 and the high-speed operation circuit 225 of FIG. 6. The decryption operation circuit 224 decrypts the encrypted data Ca to obtain TGTTACGG and GGTTGACTA.

Then, the high-speed operation circuit 225 performs matrix score calculation in the Smith-Waterman algorithm as the processing Func, and obtains GTT-AC and GTTGAC as local alignments. The encryption operation circuit 226 encrypts GTT-AC and GTTGAC, which correspond to the processing result Q, with the secret key mk so as to generate encrypted data Cb, and transmits the encrypted data Cb to the client device 406. This transmission corresponds to step S24.

The client device 406 decrypts the encrypted data Cb with the secret key mk to obtain GTT-AC and GTTGAC, which are the processing result Q. This processing corresponds to step S25.

In the example of the operational phase described above, the base sequences TGTTACGG and GGTTGACTA and the local alignment results GTT-AC and GTTGAC are not revealed on the host computer 401.

FIG. 6 is a detailed device configuration diagram of the dynamic processing circuit 22 of FIG. 1 for realizing the processing of FIG. 5.

The correspondence between FIG. 6 and the processing of FIG. 5 will be described.

(1) The input circuit 221 receives data transferred from the host computation unit 10 of the host computer 401 via the fixed processing circuit 21, and transfers the data to an appropriate circuit in the dynamic processing circuit 22.

(2) The key computation circuit 222 includes the PUF, key generation and decryption processing in elliptic ElGamal encryption, and processing of the pseudorandom function PRF, and performs the following processing in FIG. 5.

PUF_KeyGen(IV)→(HD, Kp, Ks)

PUF_KeyRep(IV, HD)→Ks

Dec(Ks, Cmk)→mk

(3) The key storage circuit 223 stores mk and Ks that are output from the key computation circuit 222. The key storage circuit 223 may be implemented as part of the key computation circuit 222. The secret keys mk and Ks are not output to the outside of the FPGA via the fixed processing circuit 21 and are used only in the dynamic processing circuit 22.

(4) The decryption operation circuit 224 performs the following processing in FIG. 5.

D(mk, Ca)→P

As an algorithm of D and E, AES-GCM may be pointed out as an example.

(5) The high-speed operation circuit 225 is an operation unit for accelerating processing with a high load in the application, and performs the following processing in FIG. 5.

Func(P)→Q

In the example described above, this indicates matrix score calculation in the Smith-Waterman algorithm.

(6) The encryption operation circuit 226 performs the following processing in FIG. 5.

E(mk, Q)→Cb

As in the case of the decryption operation circuit 224, as an algorithm of encryption E, AES-GCM may be pointed out as an example.

(7) The output circuit 227 transfers outputs of the key computation circuit 222 and the encryption operation circuit 226 to the fixed processing circuit 21. Specifically, the auxiliary data HD and the public key Kp of the key computation circuit 222 and the encrypted data Cb computed by the encryption operation circuit 226 are transferred.

Operation of the key computation circuit 222 illustrated in FIG. 7 will now be described. In the registration phase of FIG. 5, the PUF circuit 222b receives the initial value IV via the input circuit 221, outputs information utilizing manufacturing variations, and generates the identifier ID by encoding by the fuzzy extractor 222c and information compression by a hash function. The auxiliary data HD involved in the encoding is output from the output circuit 222e to the outside of the key computation circuit 222. In generating a key pair, the key pair processing circuit 222d generates a secret key Ks from the identifier ID, as mentioned in the description of Formula 2. The key pair processing circuit 222d generates a public key Kp from the secret key Ks according to the key pair generation algorithm of a public key cryptography scheme. The output circuit 222e outputs the generated public key Kp and secret key Ks to the outside of the key computation circuit 222.

In the operational phase of FIG. 5, the PUF circuit 222b receives the initial value IV via the input circuit 222a, and outputs information utilizing manufacturing variations. The fuzzy extractor 222c performs correction processing on this output, using the auxiliary data HD so as to generate the same identifier ID as that in the registration phase. The key pair processing circuit 222d generates the secret key Ks from the identifier ID. The key pair processing circuit 222d stores the secret key Ks in the key storage circuit 223 via the output circuit 222e.

The decryption of Cmk will now be described. The key pair processing circuit 222d decrypts Cmk using Ks input from the key storage circuit 223 so as to restore the secret key mk. The secret key mk is stored in the key storage circuit 223 via the output circuit 222e.

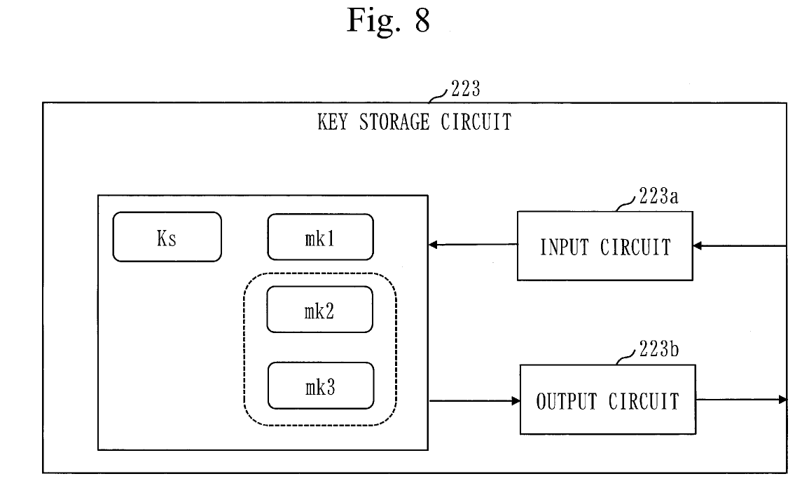

FIG. 8 illustrates the key storage circuit 223 when the application manages a plurality of secret keys mk. As illustrated in FIG. 8, the application may manage a plurality of secret keys mk. For example, in the example of database searching described above, it is assumed that a query is processed using mk1 for protecting the database. In this case, mk2 and mk3 may be used for different users. This allows control such that search results cannot be decrypted by users having mk2 and mk3.

<First Variation>

A concern in the first embodiment described above is the authenticity of the public key Kp. In FIG. 5, the server 407 transmits to the client device 406 the public key Kp corresponding to the initial value IV transmitted by the client device 406. In FIG. 5, there is no means for checking whether the public key Kp has been generated inside the FPGA 405 in the server 407.

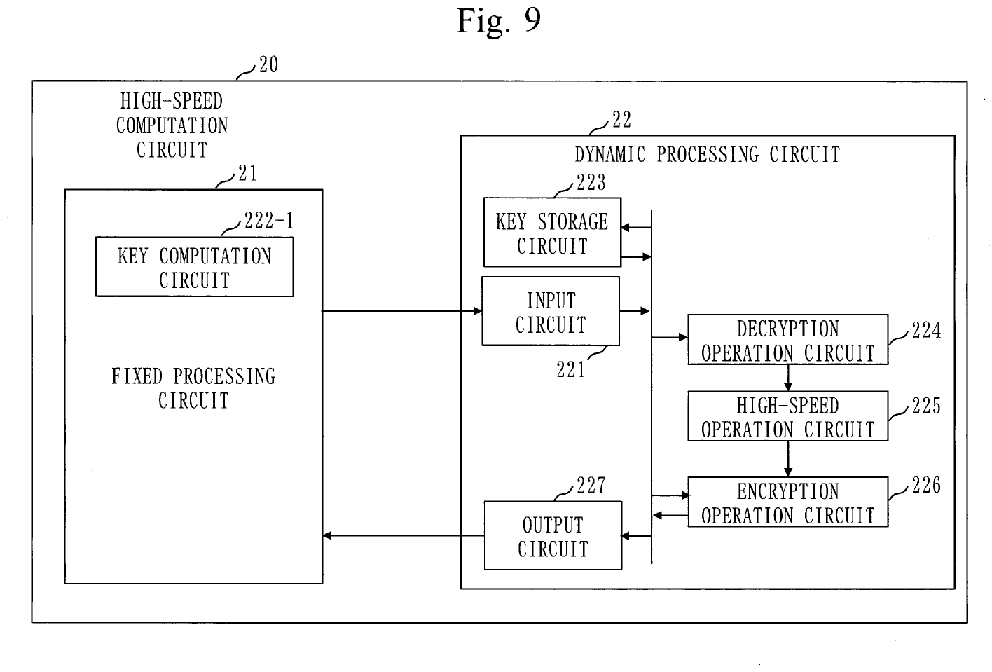

FIG. 9 illustrates the high-speed computation circuit 20 of a first variation. In the first variation illustrated in FIG. 9, the key computation circuit 222 of FIG. 7 is implemented in the fixed processing circuit 21 instead of the dynamic processing circuit 22. The key computation circuit implemented in the fixed processing circuit 21 will be referred to as a key computation circuit 222-1. That is, the FPGA 405, which is the logic circuit device, has a fixed area in which a logic circuit whose circuit configuration does not change is formed. This fixed area is the area in the fixed processing circuit 21, and the key computation circuit 222-1 is formed in the fixed processing circuit 21, which is the fixed area, as illustrated in FIG. 9. The key computation circuit 222-1 generates a pair of the same public key and the same secret key for the same initial value.

When the key computation circuit 222 is implemented in the dynamic processing circuit 22 as illustrated in FIGS. 6 and 7, if placement and wiring are changed, the secret key Ks and the public key Kp corresponding to the initial value IV may change due to the PUF function.

When the key computation circuit 222 is implemented in the fixed processing circuit 21, the same circuit is configured as the circuit of the key computation circuit 222 each time the FPGA 405 is configured. That is, there is no change in placement and wiring. Therefore, in the same FPGA 405, the secret key Ks and the public key Kp corresponding to the same initial value IV are always the same.

Utilizing the features of the first variation, the following configuration is possible.

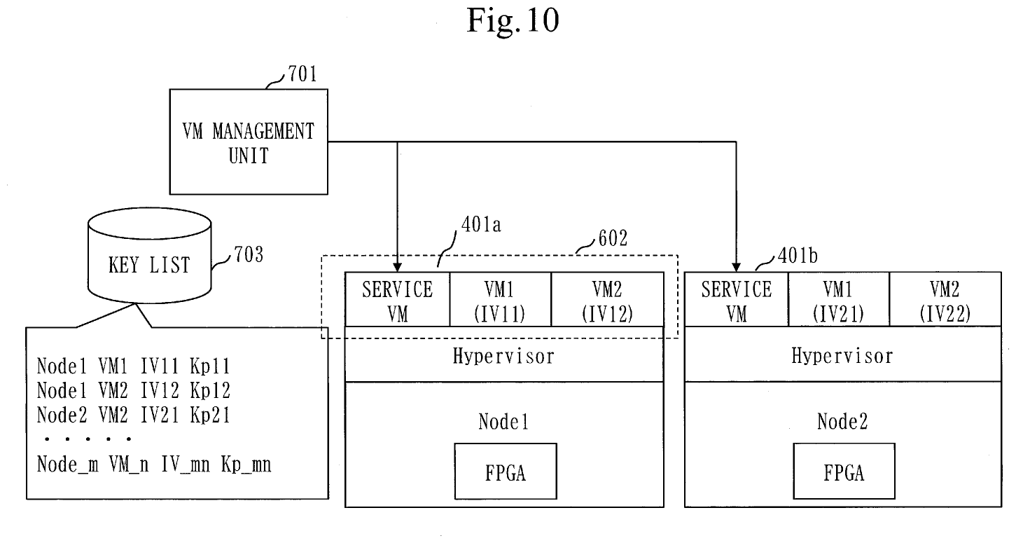

FIG. 10 illustrates host computers 401a and 401b of the first variation. As illustrated in FIG. 10, a plurality of virtual machines (VMs) operate on the two host computers 401a and 401b. There are two host computers, but this is an example and there may be three or more host computers. There are two VMs that operate on each of the host computers, but this is an example and there may be three or more VMs. A VM management unit 701 manages the plurality of host computers and the plurality of VMs that operate on the host computers.

In this case, each of the host computers is called a node. In FIG. 10, the initial value IV is determined for each VM of each node, and a key pair is generated by the key computation circuit 222-1 of FIG. 9, using the initial value IV. Using a plurality of different initial values IV, the key computation circuit 222-1 generate a pair of a public key Kp and a secret key Ks for each initial value IV.

That is, the key computation circuit 222-1 generates the same secret key Ks and public key Kp for the same initial value IV. This allows a pair of the secret key Ks and the public key Kp to be assigned to each VM of each node. The VM management unit 701 manages these keys as a key list 703.

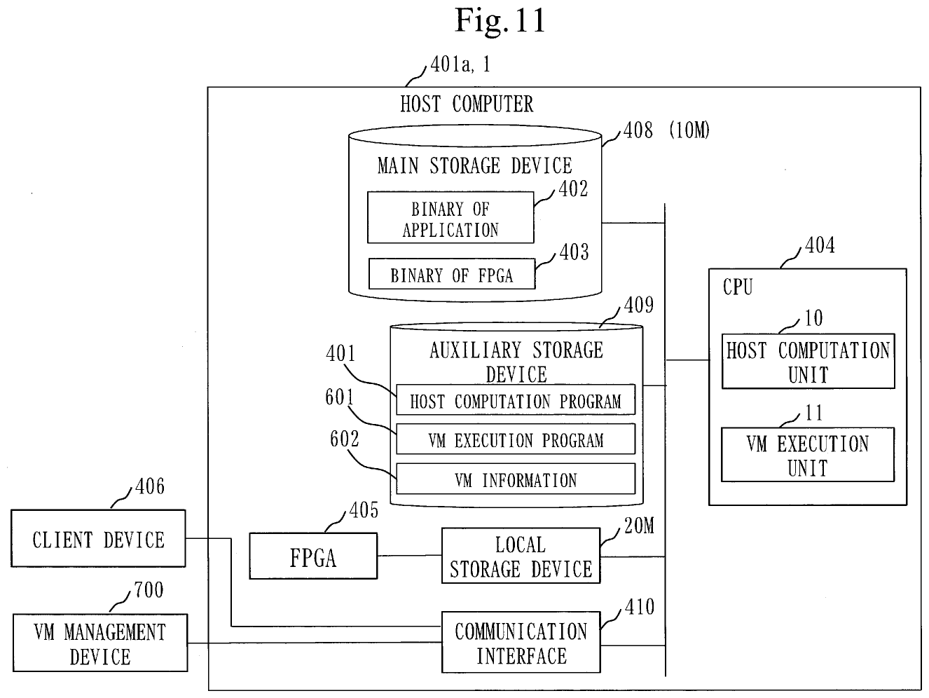

In FIG. 11 to be described later, VM information 602 is stored in the auxiliary storage device 409 of the host computer 401a. The VM information 602 is a plurality of different initial values IV. Specifically, in the host computer 401a of FIG. 10, the VM information 602 is information on the initial IV in which an initial value IV is associated with each VM.

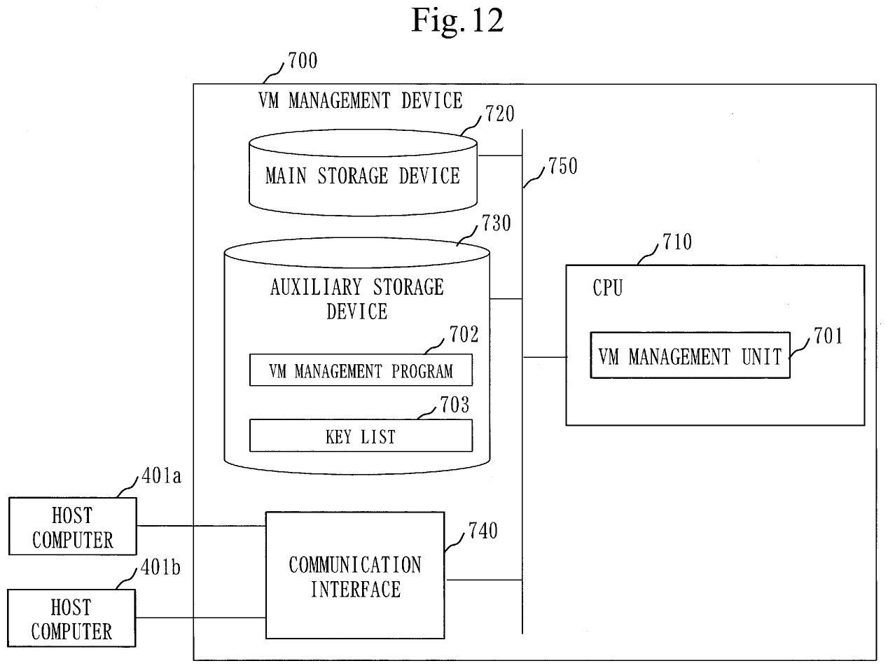

The initial values and the public keys generated from the initial value are stored as key information in association with authenticity information for guaranteeing authenticity in a key information storage device. Specifically, this is as described below. Electronic signature can be performed on the key list 703 by a reliable third party, so that the authenticity of the public keys of the key list 703 can be guaranteed. The electronic signature is the authenticity information. An auxiliary storage device 730 of a VM management device 700 to be described later with reference to FIG. 12 is the key information storage device. The key list 703 is the key information. In FIG. 10, keys are assigned according to the node and VM, but keys may be assigned for each application in a more subdivided manner. As an example of the VM management unit 701, a VM management tool represented by Openstack may be pointed out. This management tool corresponds to a VM management program 702 of FIG. 12.

Referring to FIGS. 11 and 12, hardware configurations of the host computer 401a and the VM management device 700 will be described supplementally.

FIG. 11 illustrates the hardware configuration of the host computer 401a of the first variation. The host computer 401a further has a VM execution unit 11 and a VM execution program 601 in comparison with the host computer 401 described in FIG. 3. The VM execution unit 11 is realized by execution of the VM execution program 601 by the CPU 404. The VM execution program 601 is stored in the auxiliary storage device 409. The host computer 401b also has the same hardware configuration as the host computer 401a.

FIG. 12 illustrates the hardware configuration of the VM management device 700. The VM management device 700 is a computer. The VM management device 700 includes, as hardware, a CPU 710, a main storage device 720, the auxiliary storage device 730, and a communication interface 740. The VM management device 700 has the VM management unit 701 as a functional element. The VM management unit 701 is realized by execution of the VM management program 702 by the CPU 710. The VM management program 702 is stored in the auxiliary storage device 730. The key list 703 is also stored in the auxiliary storage device 730. The VM management unit 701 communicates with the host computers 401a and 401b via the communication interface 740.

<Second Variation>

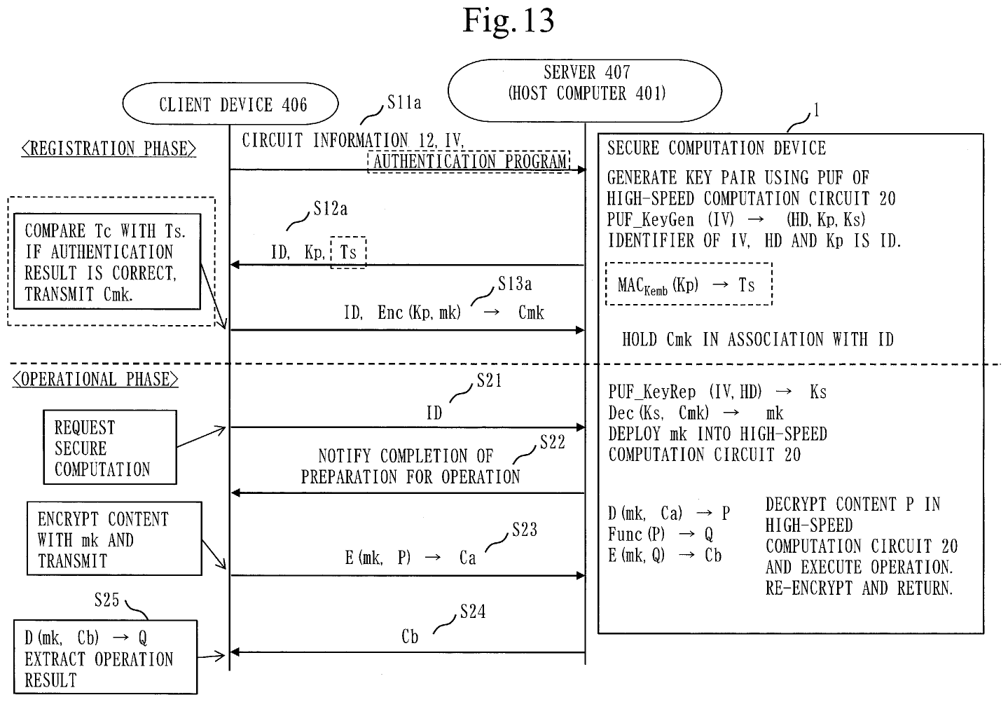

Referring to FIG. 13, a second variation of the first embodiment will now be described.

FIG. 13 is a processing flow illustrating the second variation. It is assumed that the identifier ID, instead of the auxiliary data HD, is transmitted in step 12a of FIG. 13.

The second variation is characterized in that the client device 406 can verify the public key Kp acquired in step 512a of FIG. 13. FIG. 13 differs from FIG. 5 in step S11a, step S12a, step S13a, processing to transmit Cmk by the client device 406 enclosed by dashed lines, and processing to generate an authentication value Ts by the secure computation device 1 enclosed by dashed lines. Referring to FIG. 13, the second variation of the first embodiment will be described.

The authentication value Ts is a first authentication value. An authentication value Tc, to be described later, acquired by the client device 406 by computation is a second authentication value.

When key information is applied as input data, the transmission control unit 501a of the client device 406 transmits to the server 407, which is the secure computation device 1, an authentication program that outputs an authentication value for the key information.

In a specific example to be described later, the authentication program is a message authentication code (MAC) function that uses an embedded key Kemb. The key information that is applied to the MAC function as input data is a public key Kp. The MAC function takes as input the public key Kp and outputs an authentication value T.

This relationship is expressed as

MAC_{Kemb}(Kp)=T.

Note that, in FIG. 13, the client device 406 transmits the authentication program solely. However, in the client device 406, the transmission control unit 501a may transmit the authentication program to the server 407, which is the secure computation device 1, by including the authentication program in the circuit information 12.

The encryption control unit 501b of the client device 406 acquires the first authentication value Ts together with the public key Kp from the server 407. The encryption control unit 501b applies the acquired public key Kp to the same MAC_{Kemb} as the MAC_{Kemb} transmitted to the server 407 so as to acquire the second authentication value Tc. The encryption control unit 501b compares the first authentication value Ts with the second authentication value Tc, and if it is determined that the comparison result is correct, transmits a user secret key Cmk encrypted with the public key Kp to the server 407. The correct comparison result is, for example, Ts=Tc.

Referring to FIG. 13, the above will be described specifically below.

<Step S11a>

The transmission control unit 501a transmits MAC_{Kemb}, which is the authentication program, to the server 407 in addition to the circuit information 12 and the initial value IV. In the server 407, HD, Kp, and Ks are generated, as in FIG. 5.

The key computation circuit 222 calculates the authentication value Ts as indicated below, using MAC_{Kemb} received from the client device 406.

MAC_{Kemb}(Kp)=Ts

<Step S12a>

The host computation unit 10 of the server 407 transmits the identifier ID, the public key Kp, and the authentication value Ts to the client device 406 via the communication interface 410.

<Step S13a>

The encryption control unit 501b obtains the identifier ID, the public key Kp, and the authentication value Ts from the secure computation device 1. The encryption control unit 501b applies the public key Kp acquired from the server 407 to the same MAC_{Kemb} as the MAC_{Kemb} transmitted to the server 407. That is, the encryption control unit 501b computes the following formula to acquire the second authentication value Tc.

MAC_{Kemb}(Kp)=Tc

The encryption control unit 501b compares the first authentication value Ts with the second authentication value Tc. If the comparison result is determined as correct, the encryption control unit 501b encrypts a user secret key mk with the public key Kp acquired from the server 407 so as to generate Cmk, as indicated in the formula below.

Enc(Kp, mk)→Cmk

Then, the encryption control unit 501b transmits the encrypted user secret key Cmk to the server 407.

The operation thereafter is the same as in FIG. 5.

In the second variation, the client device 406 transmits MAC_{Kemb} to the server 407. The server 407 generates the authentication value Ts from MAC_{Kemb}, and transmits the authentication value Ts to the client device 406. The client device 406 generates the authentication value Tc from MAC_{Kemb}, and compares the authentication value Tc with the authentication value Ts. Therefore, according to the second variation, the client device 406 can verify that the public key Kp is generated in the

FPGA configured based on the circuit information 12.

<Third Variation>

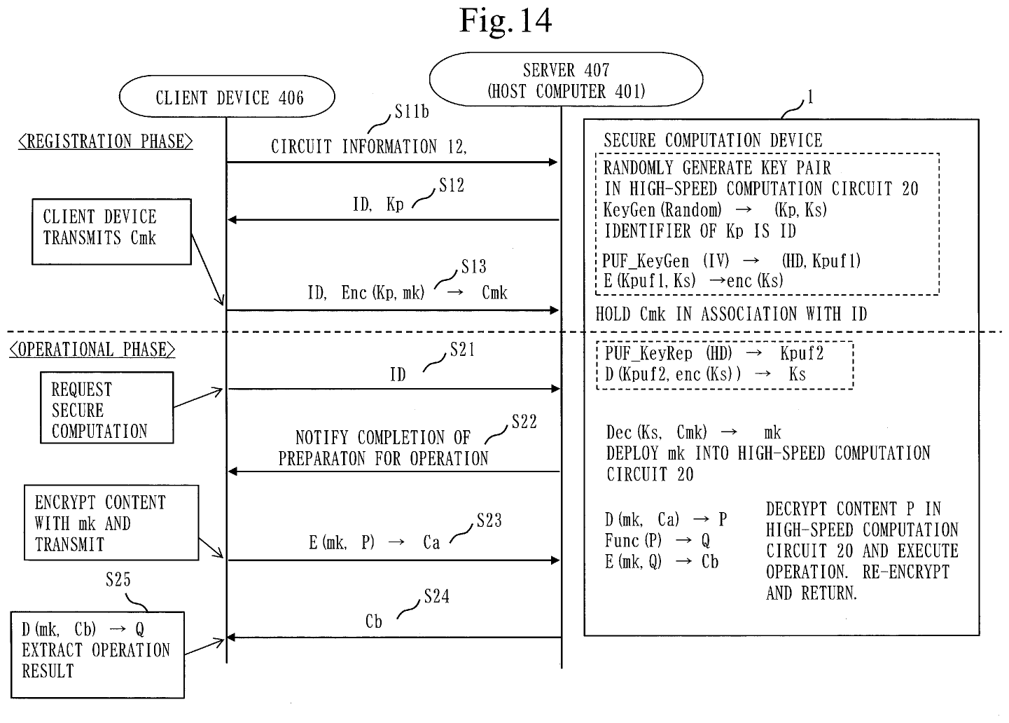

Referring to FIG. 14, a third variation of the first embodiment will now be described. It is assumed that the identifier ID, instead of the auxiliary data HD, is transmitted in step 12 of FIG. 14.

FIG. 14 is a processing flow illustrating the third variation. The third variation is characterized in that the key computation circuit 222 randomly generates a pair of a public key Kp and a secret key Ks independently of the PUF function, generates key information Kpuf using the PUF function, encrypts the secret key Ks with the key information Kpuf, and holds the encrypted secret key Ks.

Note that “using the PUF function” means using the physical unclonable function. FIG. 14 differs from FIG. 5 in that the client device 406 does not transmit the initial value IV in step S11b and also in processing by the secure computation device 1 enclosed by dashed lines.

Referring to FIG. 14, the third variation of the first embodiment will be described. The key computation circuit 222 generates first key information Kpuf1 using the physical unclonable function. The key computation circuit 222 encrypts the secret key Ks using the first key information Kpuf1. When the decryption operation circuit 224 decrypts encrypted data Ca, the key computation circuit 222 generates second key information Kpuf2 that is the same as the first key information Kpuf1, using the physical unclonable function. Using the second key information Kpuf2, the key computation circuit 222 decrypts the secret key Ks encrypted with the first key information Kpuf1. Using the decrypted secret key Ks, the key computation circuit 222 decrypts a user key Cmk encrypted by the client device 406 with the public key Kp.

Thereafter, using mk decrypted with the secret key Ks, the server 407 decrypts the encrypted data Ca to the content P, as in FIG. 5.

Referring to FIG. 14, the third variation of the first embodiment will be described.

<Step S11b>

The transmission control unit 501a transmits circuit information 12 to the server 407. The key computation circuit 222 randomly generates a key pair of a public key Kp and a secret key Ks by the following formula.

KeyGen(Random)→(Kp, Ks)

The above formula indicates that the key pair of the public key Kp and the secret key Ks is randomly generated. The identifier of the public key Kp is ID, as in FIG. 5. The key computation circuit 222 generates auxiliary data HD and first key information Kpuf1 from an initial value IV, using the PUF function.

PUF_KeyGen (IV)→(HD, Kpuf1)

The key computation circuit 222 encrypts the secret key Ks using the first key information Kpuf1.

En(Kpuf1, Ks)→enc(Ks)

The above formula indicates that the secret key Ks is encrypted using the first key information Kpuf1 so as to generate enc(Ks), which is the encrypted secret key Ks.

Steps S12 and S13 are the same as in FIG. 5.

<Step S21>

When the identifier ID is received from the client device 406, the key computation circuit 222 performs the following processing. The transmission of the identifier ID by the client device 406 is a request for processing on the encrypted data Ca. When the decryption operation circuit 224 decrypts the encrypted data Ca, the key computation circuit 222 generates second key information Kpuf2 that is the same as the first key information Kpuf1, using the PUF function. That is, the key computation circuit 222 executes the following formula to generate the second key information Kpuf2 from the auxiliary data HD. The second key information Kpuf2 is the same as the first key information Kpuf1.

PUF_KeyRep (HD)→Kpuf2

The key computation circuit 222 decrypts enc(Ks) with the second key information Kpuf2, as indicated in the following formula, to obtain the secret key Ks.

De(Kpuf2, enc(Ks))→Ks

The above formula indicates that enc(Ks) is decrypted using the second key information Kpuf2. Using the decrypted secret key Ks, the key computation circuit 222 decrypts the user secret key Cmk encrypted with the public key Kp, as indicated in the following formula.

Dec(Ks, Cmk)→mk

The processing thereafter is the same as in FIG. 5.

In the third variation, a pair of the public key Kp and the secret key Ks is generated without using the PUF function, so that there is no need to transmit the initial value IV from the client device 406.

### Effects of First Embodiment

(1) In the first embodiment, in the operational phase of FIG. 5 the input and output of the processing Func are deployed only in the key computation circuit 222, the high-speed operation circuit 225, and the encryption operation circuit 226, as illustrated in FIG. 6. That is, the input and output of the processing Func are deployed only in the secure area of the FPGA 405 of FIG. 2.

Therefore, even if information of the host computer 401 is leaked, the input and output and intermediate values of the processing Func are not revealed.

(2) On the host computer 401, the secret key mk is managed as Cmk encrypted with the public key Kp, and Cmk is deployed only in the FPGA 405.

Therefore, even an administrator of the host computer 401 cannot violate the privacy of the secret key mk.

The embodiment including the three variations have been described above. One of the embodiment and the three variations may be partially implemented. Alternatively, two or more of the embodiments and the three variations may be implemented in combination.

The present invention is not limited to the embodiment described above, and various modifications are possible as necessary.

### REFERENCE SIGNS LIST

Ks: secret key; Kp: public key; P: content; Q: processing result; 1: secure computation device; 10: host computation unit; 10M: host storage unit; 11: VM execution unit; 20M: local storage device; 20: high-speed computation circuit; 21: fixed processing circuit; 22: dynamic processing circuit; 221: input circuit; 222: key computation circuit; 222a: input circuit; 222b: PUF circuit; 222c: fuzzy extractor; 222d: key pair processing circuit; 222e: output circuit; 223: key storage circuit; 224: decryption operation circuit; 225: high-speed operation circuit; 226: encryption operation circuit; 227: output circuit; 401, 401a, 401b: host computer; 402: binary; 403: binary; 404: CPU; 405: FPGA; 406: client device; 407: server; 408: main storage device; 409: auxiliary storage device; 410: communication interface; 412: host computation program; 501: CPU; 501a: transmission control unit; 501b: encryption control unit; 501c: decryption control unit; 501d: control program; 502: main storage device; 503: auxiliary storage device; 504: communication interface; 601: VM execution program; 700: VM management device; 701: VM management unit; 702: VM management program; 703: key list; 710: CPU; 720: main storage device; 730: auxiliary storage device; 740: communication interface

1. A client device that communicates with a secure computation device,
the secure computation device including:
processing circuitry; and a logic circuit device in which a circuit configuration of a logic circuit can be changed by circuit information,
wherein the processing circuitry of the secure computation device forms a plurality of logic circuits in the logic circuit device, using the circuit information associated with an application, and
wherein the logic circuit device in which the plurality of logic circuits are formed includes:
a key computation circuit to generate a pair of a public key and a secret key, acquire a user secret key encrypted with the public key, and decrypt the encrypted user secret key with the secret key;
a decryption operation circuit to acquire content encrypted with the user secret key, and decrypt the encrypted content with the decrypted user secret key;
a content operation circuit to perform processing associated with the application on the decrypted content so as to generate processed content, which is a processing result of the content;
an encryption operation circuit to encrypt the processed content with the user secret key; and
an output circuit to output the encrypted processed content,
the client device comprising:
processing circuitry to:
transmit the circuit information to the secure computation device;
acquire the public key from the secure computation device, encrypt the user secret key with the public key, encrypt the content with the user secret key, and transmit the user secret key encrypted with the public key and the content encrypted with the user secret key to the secure computation device; and
acquire the encrypted processed content from the secure computation device, and decrypt the encrypted processed content with the user secret key,
wherein when key information is applied as input data, the processing circuitry of the client device transmits to the secure computation device an authentication program that outputs an authentication value for the key information, and
wherein the processing circuitry of the client device acquires a first authentication value together with the public key from the secure computation device, applies the public key as the key information to the same authentication program as the authentication program transmitted to the secure computation device so as to acquire a second authentication value, compares the first authentication value with the second authentication value, and when a comparison result is determined as correct, transmits the encrypted user secret key to the secure computation device.

2. The client device according to claim 1,
wherein the key computation circuit generates the pair of the public key and the secret key, using an initial value.

3. The client device according to claim 2,
wherein the logic circuit device has a fixed area in which a logic circuit whose circuit configuration does not change is formed, and
wherein the key computation circuit is formed in the fixed area, and generates a pair of the same public key and the same secret key for the same initial value.

4. The client device according to claim 3,
wherein the key computation circuit generates a pair of a public key and a secret key for each initial value, using a plurality of different initial values.

5. The client device according to claim 4,
wherein the initial values and the public keys generated from the initial values are stored in association with authenticity information for guaranteeing authenticity in a key information storage device to store key information.

6. The client device according to claim 1,
wherein the key computation circuit acquires the content encrypted with the user secret key from an encrypted content storage device to store the content encrypted with the user secret key.

7. The client device according to claim 1,
wherein the key computation circuit generates first key information using a physical unclonable function, and encrypts the secret key using the first key information, and when the decryption operation circuit decrypts the encrypted content, the key computation circuit generates second key information that is same as the first key information, using the physical unclonable function, decrypts the secret key encrypted with the first key information using the second key information, and decrypts the encrypted user secret key with the secret key.

8. The client device according to claim 1,
wherein the processing circuitry of the client device transmits the authentication program to the secure computation device by including the authentication program in the circuit information.

9. The client device according to claim 2,
wherein the key computation circuit acquires the content encrypted with the user secret key from an encrypted content storage device to store the content encrypted with the user secret key.

10. The client device according to claim 3,
wherein the key computation circuit acquires the content encrypted with the user secret key from an encrypted content storage device to store the content encrypted with the user secret key.

11. The client device according to claim 4,
wherein the key computation circuit acquires the content encrypted with the user secret key from an encrypted content storage device to store the content encrypted with the user secret key.

12. The client device according to claim 5,
wherein the key computation circuit acquires the content encrypted with the user secret key from an encrypted content storage device to store the content encrypted with the user secret key.
